(19) United States
(12) Patent Application Publication
(10) Pub. No.: US 2014/0372448 A1
(43) Pub. Date: Dec. 18, 2014

(54) SYSTEMS AND METHODS FOR SEARCHING CHEMICAL STRUCTURES

(71) Applicant: American Chemical Society, Washington, DC (US)

(72) Inventors: ANDREW S. OLSON, Hillard, OH (US); Scott M. COPLIN, Columbus, OH (US); Martin L. FULLER, Newark, OH (US); Andre P. SMITH, Worthington, OH (US); Joseph F. SJOSTROM, Worthington, OH (US)

(21) Appl. No.: 14/304,386

(22) Filed: Jun. 13, 2014

Related U.S. Application Data
(60) Provisional application No. 61/835,336, filed on Jun. 14, 2013.

(51) Int. Cl. G06F 17/30

(52) U.S. Cl. CPC G06F 17/30321
USPC 707/741

(57) ABSTRACT

Systems, methods, and computer-readable media are provided for distributing structured data sets. In accordance with one implementation, a computer-implemented method is provided that comprises operations performed by one or more processors, including receiving structured data, the structured data including a plurality of entity data elements and one or more relationship data elements; assigning universal identifiers to the entity data elements; and determining one or more relationship instances, the one or more relationship instances corresponding to one or more relationships between the assigned universal identifiers according to the one or more relationship data elements. The method also includes segmenting the entity data elements into sub elements having types, and distributing the sub elements among a plurality of entity partitions and distributing the determined one or more relationship instances among one or more relationship partitions.

### CROSS REFERENCE TO RELATED APPLICATION

This application claims the benefit of priority to U.S. Provisional Application No. 61/835,336 filed with the United States Patent and Trademark Office on Jun. 14, 2013, and entitled “CHEMICAL STRUCTURE SEARCHING COMPUTER SYSTEMS AND SOFTWARE,” which is hereby incorporated by reference in its entirety.

### BACKGROUND

The present disclosure relates to computer systems and methods for constructing searchable structured datasets and/or information, as well as computer systems and methods for distributing structured datasets and/or information. Certain embodiments of the present disclosure provide computer systems and methods for searching chemical structure data and related data and/or information entities.

The information age has been defined by the dramatic expansion in both the number and kind of the channels of communication. Both the casual consumer and the specialized professional engage in a constant sifting, parsing, organizing, presenting, and archiving of data. Many industries are now completely driven by the rapid access to and synthesis of disparate datasets into a comprehensible body of information that can be intuitively queried to yield accurate results. The prototypical example of this scenario is the Internet. A broad component of Internet technologies aim at the presentation and conveyance of data: HTTP (along with other “backbone” elements of the Internet, e.g. IP addresses and DNS), PHP, CSS, XML, HTML, POP/SMTP, etc. But an equally significant component of the Internet includes search and retrieval technologies, of which the most critical are search engines, which index the otherwise unstructured multimedia content of the Internet and provide an interface by which users may query the indexed information, sort through the retrieved data, and arrive at the most relevant information. Given the monumental scale of such a task, search and retrieval technologies have proven critical to the mass appeal and adoption of the Internet by providing a practical solution to the proverbial needle-in-haystack problem of quickly and accurately locating relevant information.

However, the Internet represents only one body of information. Entities large and small—even down to the level of a single individual—generate massive quantities of their own privately held or restricted data. And whereas information on the Internet is characterized by its diversity, breadth, and disorganization, the information produced by such entities, e.g. corporations, non-profit, government agencies, etc., can be extremely detailed, specific, and structured. Such “enterprise” content may come in many different forms and address different subject areas. A pharmaceutical corporation, for example, grapples not only with the need to keep careful and detailed scientific records of drug trials, studies, chemical syntheses, plant operations, quality control, etc., but also information of a more commercial and regulatory nature, such as invoices, budget projections, marketing materials, government regulatory compliance filings, financials, etc. This wide swath of data may be stored in various forms such as spreadsheets, multidimensional relational databases, scanned images of paper documents, native digital versions of documents, videos, pictures, presentations, etc. A routine problem faced by organizations is the need to accurately interpret their enterprise data in order to make informed decisions and plan future endeavors. There is accordingly an analogous problem faced by such organizations in the search and retrieval of relevant enterprise content.

Certain entities further specialize in the collection, organization, and presentation of particular datasets of extreme, but narrow, interest to professional audiences. For example, corporations such as LexisNexis® and Westlaw® have proven critical to the legal profession by indexing, summarizing, and classifying judicial opinions and other such legal documents. ProQuest®, Bloomberg®, and other such information services provide similar services for market data, news reports, journalism, etc. For these and other such information services, the concept of enterprise data markedly expands because these organizations necessarily seek out new forms of information in order to remain at the cutting edge. In addition to a need for robust search and retrieval capability, these organizations require flexibility in order to accommodate new sources of relevant data in whatever medium they may exist.

An “information access platform” (IAP) is a technological solution in these aforementioned contexts. In general, IAP products aim at providing compatibility with existing Internet technologies, scalability, and cost-effective content delivery. However, existing IAP software technologies do not adequately address several problems that arise, particularly in the context of specialized information services. For illustrative purposes, consider the field of chemical informatics which generally focuses on information relating to chemical compounds. A description of a single compound encompasses a myriad of potential properties, e.g. chemical structure, polymorphic forms, chemico-physical properties, synthesis reactions, downstream reactions, applications, etc. Moreover, a compound-level description is only one type of information relevant to a wide swath of interested parties, which include, e.g., researchers in the pharmaceutical and chemical industries, regulatory/administrative agencies, academics and universities, and commercial entities. Other sources of relevant information include research journal articles, regulatory filings, patent information, sales data, manufacturing sources, trade names and trademarks, books and other such treatises.

Accordingly, one problem faced by information services not addressed by existing IAP technologies is the need for an inherently extensible platform capable of not only collating and indexing specialized information sources, but presenting such data in new formats. Another unaddressed problem is an increasing desire by users for the ability to cross-index search results across disparate domains of data. For example (again relying on the illustrative field of chemical informatics), a user may initially desire to locate compounds having bulk phase forms satisfying particular physical properties, e.g. flexural modulus, optical clarity. However, the user may then jump from a property-based compound search to further limit the search by the presence of a particular chemical structural characteristic, for example by excluding compounds having structures similar to bisphenol A. The user may then desire to cross-index the search against patent sources, regulatory data, and potential manufacturers/suppliers. These searches require intensive computation that the current IAP products cannot support both in terms of technological feasibility/performance needs and cost-effectiveness.

A particular problem in the field of chemical informatics is the need for IAP technologies that enable chemical structure searching or searching based on the molecular connectivity and geometries. A highly desired variant of a chemical structure search is a substructure search in which a partial structural motif is matched to any superstructure containing the motif. Notably, the problems highlighted above—extensibility and cross-indexing—are exacerbated in the context of a substructure search because such searches belong to the class of NP complete computational problems. Algorithms and techniques of chemical structure searching and substructure searching include connection tables, augmented atoms, screening, etc.

Accordingly, there is a need for computer systems and methods for constructing searchable structured datasets and distributing search results obtained from the searchable structured datasets to databases searchable by a user. There is also a need for improved computer systems and methods for conducting searches of chemical structures and substructures.

### SUMMARY

The present disclosure relates to embodiments for distributing structured data sets. Moreover, embodiments of the present disclosure include systems, methods, and computer-readable media for distributing structured data sets. As will be appreciated, embodiments of the present disclosure may be implemented with any combination of hardware, software, and/or firmware, including computerized systems and methods embodied with processors or processing components.

In some embodiments, a computer-implemented system is provided for distributing structured data sets. The system includes a memory device that stores a set of instructions and at least one processor. The at least one processor executes the instructions to receive structured data. The structured data may include entity data elements and/or relationship data elements. The at least one processor also executes the instructions to assign universal identifiers to the entity data elements. The at least one processor may further execute the instructions to determine one or more relationship instances, the one or more relationship instances corresponding to one or more relationships between the assigned universal identifiers according to the one or more relationship data elements. Moreover, the at least one processor executes the instructions to segment the entity data elements into sub elements having types, and distribute the sub elements among a plurality of entity partitions. Further still, the at least one processor may execute the instructions to distribute the determined one or more relationship instances among one or more relationship partitions.

In some embodiments of the present disclosure, a method is provided for distributing structured data sets. The method includes receiving structured data. The structured data may include entity data elements and/or relationship data elements. The method also includes assigning first universal identifiers to the entity data elements. The method may further include determining one or more relationship instances, the one or more relationship instances corresponding to one or more relationships between the assigned universal identifiers according to the one or more relationship data elements. Moreover, the method includes segmenting the entity data elements into sub elements having types, and distributing the sub elements among a plurality of entity partitions. Still further, the method may include distributing the determined one or more relationship instances among one or more relationship partitions.

In some embodiments of the present disclosure, a non-transitory computer-readable medium storing instructions is provided. The instructions, when executed by at least one processor, cause the at least one processor to perform operations including receiving structured data. The structured data may entity data elements and one or more relationship data elements and assigning universal identifiers to the entity data elements. The method may also include determining one or more relationship instances, the one or more relationship instances corresponding to one or more relationships between the assigned universal identifiers according to the one or more relationship data elements. The method further includes segmenting the entity data elements into sub elements having types, and distribute the sub elements among a plurality of entity partitions. The method may further include distributing the determined one or more relationship instances among one or more relationship partitions.

Additional aspects and aspects consistent with the present disclosure will be set forth in part in the description which follows, and in part will be obvious from the description, or may be learned by practice of aspects of the present disclosure, as claimed.

It is to be understood that both the foregoing general description and the following detailed description are explanatory only and are not restrictive of the claimed subject matter.

### BRIEF DESCRIPTION OF THE DRAWINGS

The accompanying drawings, which are incorporated in and constitute part of this specification, and together with the description, illustrate and serve to explain the principles of various example embodiments and aspects.

FIG. 1 illustrates an example system environment for implementing some embodiments and aspects of the present disclosure.

FIG. 2 illustrates an example electronic apparatus or system for implementing some embodiments and aspects of the present disclosure.

FIG. 3 illustrates an example compilation process according to some embodiments and aspects of the present disclosure.

FIG. 4 illustrates an example MapReduce architecture according to some embodiments and aspects of the present disclosure.

FIG. 5 illustrates an example data flow diagram according to some embodiments and aspects of the present disclosure.

FIG. 6 illustrates an example method for distributing structured data sets according to some embodiments and aspects of the present disclosure.

FIG. 7 illustrates another example method for distributing structured data sets according to some embodiments and aspects of the present disclosure.

FIG. 8 illustrates an example instantiation of an IAP Server component framework according to some embodiments and aspects of the present disclosure,

FIG. 9 illustrates a detailed view of a portion of the IAP Server component framework illustrated in FIG. 8 according to some embodiments and aspects of the present disclosure.

FIG. 10 illustrates an example metadata model according to some embodiments and aspects of the present disclosure.

### DETAILED DESCRIPTION

Reference will now be made in detail to the aspects of the present disclosure, examples of which are illustrated in the accompanying drawings. Wherever possible, the same reference numbers will be used throughout the drawings to refer to the same or like parts.

Certain embodiments of computer systems and software in accordance with the present disclosure may comprise the step of providing one or more entity data elements and one or more relationship data elements. An entity data element may comprise or more attributes, searchables, and representations. A relationship data element may specify a unidirectional or bidirectional relationship between two entity data elements. Certain embodiments of computer systems and software in accordance with the present disclosure may further include the step of constructing a metadata model from the entity data and relationship data. The metadata model may be expressed using a structured markup programming language such as extensible markup language (XML).

Certain embodiments of computer systems and software in accordance with the present disclosure may further include the step of compiling one or more digests from the entity data and relationship data using one or more compiler plugins. The one or more compiler plugins may specify which entity data elements are compiled into which digest and further specify the structure of the resulting digest. Certain embodiments of computer systems and software in accordance with the present disclosure may further include the step of reading a digest using one or more IAP server plugins. In particular embodiments, the or more compiler plugins may be paired with an IAP server plugin. A compiler-server plugin pair may allow the IAP server plugin to read a digest based on the structure of the digest as specified by the compiler plugin.

Accordingly, computer systems and methods in accordance with the present disclosure may allow for arbitrary entity data element attributes to be formatted into a searchable structured dataset that can be queried based on those attributes and searchable elements. By specifying a relationship between entity data elements using relationship data elements and including relationship data elements in the or more digests, computer systems and software in accordance with the present disclosure may afford the ability cross-index between different types of entity data elements using little computational power. In certain embodiments, the plugins correspond to the metadata model.

An entity data element may include a searchable connection table or other like data needed to perform a chemical structure search and/or substructure search. Computer systems and software in accordance with the present disclosure may comprise a compiler plugin used in the compiling step to construct a digest of searchable structured information which includes the necessary chemical structure information. An IAP server plugin paired with the compiler plugin may then be used in the reading step so that a query based on a chemical structure or substructure representation may be performed.

Systems in accordance with the present disclosure may comprise one or more hardware processors. Certain embodiments of systems in accordance with the present disclosure comprise a plurality of hardware processors organized into different sets or one or more hardware processors, each set being configured by computer-readable instructions such that upon execution cause the systems to perform methods in accordance with the present disclosure.

### IAP Content Compiler Description

In certain embodiments, an IAP Compiler is disclosed. The IAP Compiler uses a metamodel to describe its input structured content. Products may supply structured content to the IAP Compiler that contains named entity types. Each named entity type may include one or more named attribute types, one or more named search types, one or more named ordering types, and/or one or more named representation types. Each entity instance has a unique key. Each attribute type contained in an entity instance defines a range of bins that may be nominal, ordered, interval, or a ratio. Plug-ins may be configured for each search and representation type contained in an entity instance.

Products may also supply input that contains named relationship types that define a relationship is between two entity types. Each relationship may be referred to as a relationship instance. The relationship instances may specify end points in terms of named entity types and entity instance keys.

The sum total of all the entity, attribute, search, ordering, representation, and relationship types that are passed to the IAP Compiler may be referred to as a product model. The output of the IAP Compiler is a self-describing IAP Digest that contains 1) the product model and 2) a collection of entity and relationship instances.

The IAP Compiler internally generates and manages a multi-dimensional vector space in the IAP Digest to represent all types and instances. Dense arrays contribute to fast online query execution. Additional dimensions may be introduced by plug-ins, e.g., search fields, representation sub-types. In addition to the dimensions associated with the metamodel and instances, the IAP Digest also includes dimensions to match online execution resources. These additional dimensions describe geometric decomposition and are called alpha, beta, and (optionally) delta database shards or partitions.

IAP Content Compilation software transforms Enterprise Content into an IAP Digest, which is indexed and sectioned as specified by a set of computer configuration files and plugins. It may comprise of a series of MapReduce tasks built upon the Hadoop cluster processing framework.

An “attribute” may be a sub-element of an entity, or a characteristic or inherent part of an entity. An attribute may be a discrete set of bin values that are used to categorize entities across a facet with a reasonably bounded set of values. Examples are language, publication year, author, etc. Each entity instance may have one or more attributes that may be assigned one or more bin values.

A “digest” may refer to compiled output produced by IAP content compilation.

A “digest section” may be referred to as an “entity partition,” and may encompass distinct elements within the digest, the quantity of which may be determined in the compiler configuration. Examples of digest sections (or entity partitions) include attributes, shards, sub-shards, and segments.

An “entity” may refer to different types of content, for example, a document, an author, a substance, etc. Entities may be assigned universal identifiers (UIDs) used to order the entities in a digest.

A “key” may refer to the first part of a MapReduce key-value pair “Hadoop key”), or the key of an entity instance (an “entity key”).

A “model” may refer to a metadata model which specifies the extent of data contained in a digest.

A “phase” may refer to a MapReduce task pair that performs part of the compilation.

A “projection” may refer to a direction-specific (e.g. forward or rev transversal of a relationship.

A “relationship” may refer to an association between two entities, and may consist of a source and target. For example, a document entity may refer to a substance entity. Multiple relationships may exist between the same two entities.

A “representation” may comprise parts of structured content retrievable for an entity instance. The structure of a representation may be specified by a plug-in component that extends an IAP Server framework. An entity can have one, or more representations.

“Searchable” refers to portions of structured content that can be indexed for efficient searching. A searchable may provide a method for searching for entity instances based on abstract queries. The functionality of a searchable may be specified by a plug-in component that extends an IAP Server framework. An entity can have one or more searchable elements. As an example, a “Face Recognition” search may be used as a searchable for “Person” entity instances.

A “segment” may refer to a section of digested representation data.

A “shard” may refer a section of digested searchable data. A “sub-shard” may refer to a subdivision of a shard.

“Structured content” may refer to a normalized form of compiler input data.

“Transversal” may refer to a section of digested relationship data.

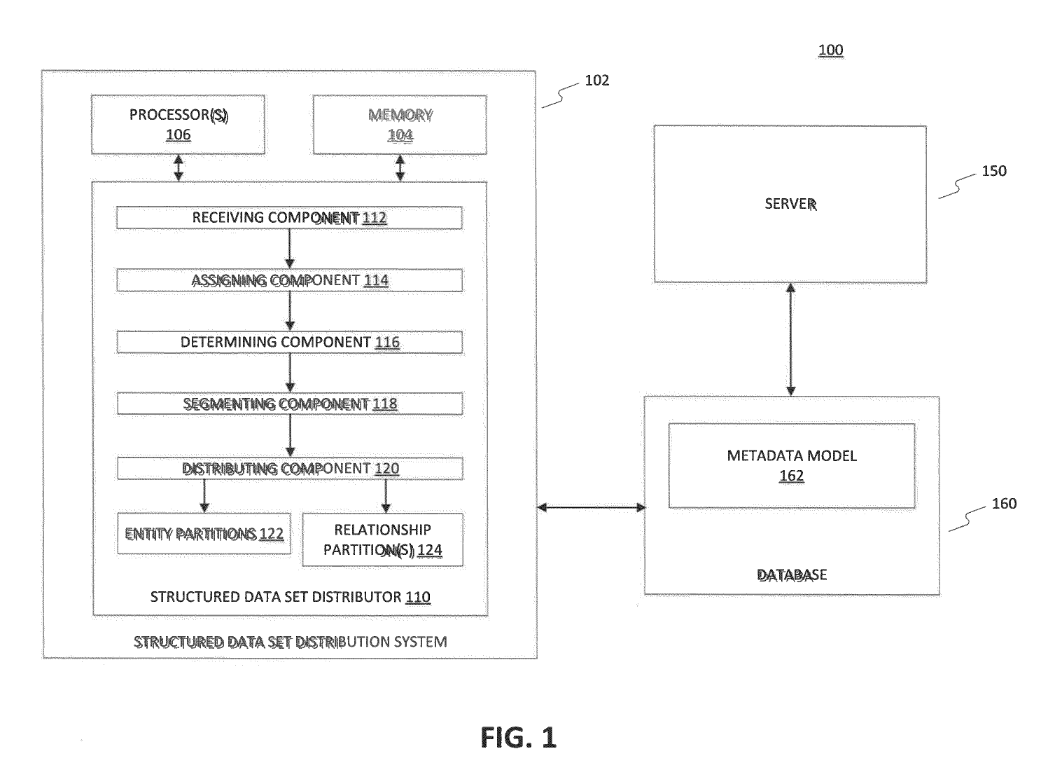

FIG. 1 is a block diagram of an example system environment 100 for implementing aspects of the present disclosure. For example, system environment 100 may be used for IAP content compilation and distribution of structured data sets. The arrangement and number of components in system 100 is provided for purposes of illustration. Additional arrangements, number of components, and other modifications may be made, consistent with the present disclosure.

As shown in the example embodiment of FIG. 1, system environment 100 may include a structured data set distribution system 102. By way of example, structured data set distribution system 102 may include smartphones, tablets, netbooks, electronic readers, personal digital assistants, personal computers, laptop computers, desktop computers, large display devices, and/or other types of electronics or communication devices. In some embodiments, structured data set distribution system 102 are implemented with hardware devices and/or software applications running thereon. Also, in some embodiments, structured data set distribution system 102 may implement aspects of the present disclosure without the need for accessing another device, component, or network. In some embodiments, server 150 may implement aspects and features of the present disclosure without the need for accessing another device, component, or network. In yet other embodiments, structured data set distribution system 102 may be configured to communicate to and/or through a network (not shown) with other clients and components, such as server 150 and database 160, and vice-versa.

In some embodiments, the network may include any combination of communications networks. For example, the network may include the Internet and/or any type of wide area network, an intranet, a metropolitan area network, a local area network (LAN), a wireless network, a cellular communications network, etc.

In some embodiments, structured data set distribution system 102 may include one or more processors 106 for executing instructions. Processors suitable for the execution of instructions include, by way of example, both general and special purpose microprocessors, and any one or more processors of any kind of digital computer.

As further illustrated in FIG. 1, structured dataset distribution system 102 may include one or more storage devices configured to store data and/or software instructions used by the one or more processors 106 to perform operations consistent with disclosed aspects. For example, structured dataset distribution system 102 may include main memory 104 configured to store one or more software programs that performs functions or operations when executed by the one or more processors 106. By way of example, main memory 104 may include NOR or NAND flash memory devices, Read Only Memory (ROM) devices, Random Access Memory (RAM) devices, etc. Structured dataset distribution system 102 may also include a storage medium (not shown). By way of example, the storage medium may include hard drives, solid state drives, tape drives, RAID arrays, etc. Although FIG. 1 shows only one main memory 104, structured dataset distribution system 102 may include any number of main memories 104 and storage mediums. Further, although FIG. 1 shows main memory 104 as part of structured dataset distribution system 102, main memory 104 and/or the storage medium may be located remotely and structured dataset distribution system 102 may be able to access main memory 104 and/or the storage medium via the network.

In some embodiments, structured data set distribution system 102 may include one or more structured data set distributors 110 to perform operations consistent with disclosed aspects. For example, structured data set distributor 110 may be configured to perform various aspects of distributing structured data sets consistent with the present disclosure. Although FIG. 1 shows processor 106 and memory 104 as separate from structured data set distributor 110, processor 106 and/or main memory 104 may be included in structured dataset distributor 110, or structured data distributor 110 may be included in processor 106 and/or memory 104.

Structured data set distributor may include a receiving component 112. In certain embodiments, receiving component 112 may be configured to receive structured data. The structured data may be comprised in any form of input. For example, the structured data may include text, images, audio, videos, chemical formulas and structures, or any combination thereof.

Further, the structured data may include a plurality of entity data elements and one or more relationship data elements. The plurality of entity data elements may be categorized as any number of entity data element types. For example, an entity data element may be categorized as one of a “doc” element type or an “author” element type.

The structured data may be stored in a database 160. Database 160 may be an IAP model output that is built up from the structured content. The structured data may be stored in database 160 as an extensible markup language (XML) file or a protobuf (.pbuf) file.

The structured content may be stored in database 160 so that it conforms to a metadata model 162. Metadata model 162 may be used to clarify and constrain the types of searches and inquiries answered by system environment 100. Metadata model 162 can easily be modified to support new types of structured data and new functionality, and it enables functionality with the IAP platform rather than having to rely on third-party software.

In some embodiments, structured data set distributor 110 may include an assigning component 114. Assigning component 114 may be configured to assign universal identifiers to the entity data elements. For example, the universal identifiers may be numerical identifiers that are assigned in sequential order to entity data elements or instances. Assigning component 114 may assign the numerical universal identifiers sequentially to each entity data element of an entity data element type. As an example of the above, the structured data may include three “author” entity data elements and three “doc” entity data elements. Assigning component 114 may assign numerical universal identifiers 0-2 to the three “author entity data elements (e.g., author-0, author-1, and author-2) and numerical universal identifiers 0-2 to the three “doc” entity data elements (e.g., doc-0, doc-1, and doc-2).

As further illustrated by FIG. 1, structured data set distributor 110 may include a determining component 116. Determining component 116 may be configured, for example, for determining relationship instances. In certain embodiments, determining component 116 may determine one or more relationship instances. A relationship instance may correspond to one or more relationships between the assigned universal identifiers according to the one or more relationship data elements. The one or more relationship data elements may include a source sub-element and a target sub-element. The source and target sub-elements may be used to define a relationship or an association between two entity data elements. For example, a relationship data element that contains a source sub-element “doc” and a target sub-element “author” may define the relationship “doe authoredby author” which associates a document with the author of the document. Such a relationship may be referred to as a relationship transversal.

Structured data distributor 110 may include a segmenting component 118. Segmenting component 118 may be configured, for example, for segmenting entity data elements into sub-elements elements having types.

A sub-element of an entity data element may have one of various sub-element types including, for example, an attribute sub-element, a representation sub-element, or a searchable sub-element. An “attribute” may be used to categorize sub-elements across a facet with a reasonably bounded set of values. As an example, an attribute sub-element may be a language in which a document was written, a publication year of the document, an author of the document, or any other attributes known in the art. A representation sub-element may comprise parts of structured content retrievable for an entity data element. A searchable sub-element may refer to portions of structured content that can be indexed for efficient searching.

Assigning component 114 may also be configured to assign universal identifiers to the sub-elements. For example the sub-elements may be assigned numerical universal identifiers by assigning component 114.

As illustrated by FIG. 1, structured data set distributor 110 may include one or more partitions that make up the IAP Digest directory structure. For example, structured data set distributor 110 may include a distributing component 120 that may be configured for distributing sub-elements among entity partitions. An entity partition, such as entity partition 122, may include various types of database partitions including database shards, sub-shards, and segments. Distributing component 120 may distribute the sub-elements among entity partitions 122 based (or according to) the sub-element types or the numerical universal identifiers assigned to the sub-elements.

Distributing component 120 may also be configured for distributing relationship instances among relationship partitions. A relationship partition, such as relationship partition 124, may store relationship instances that define a relationship transversal based on universal identifiers assigned to source sub-elements and target sub-elements of relationship entity elements.

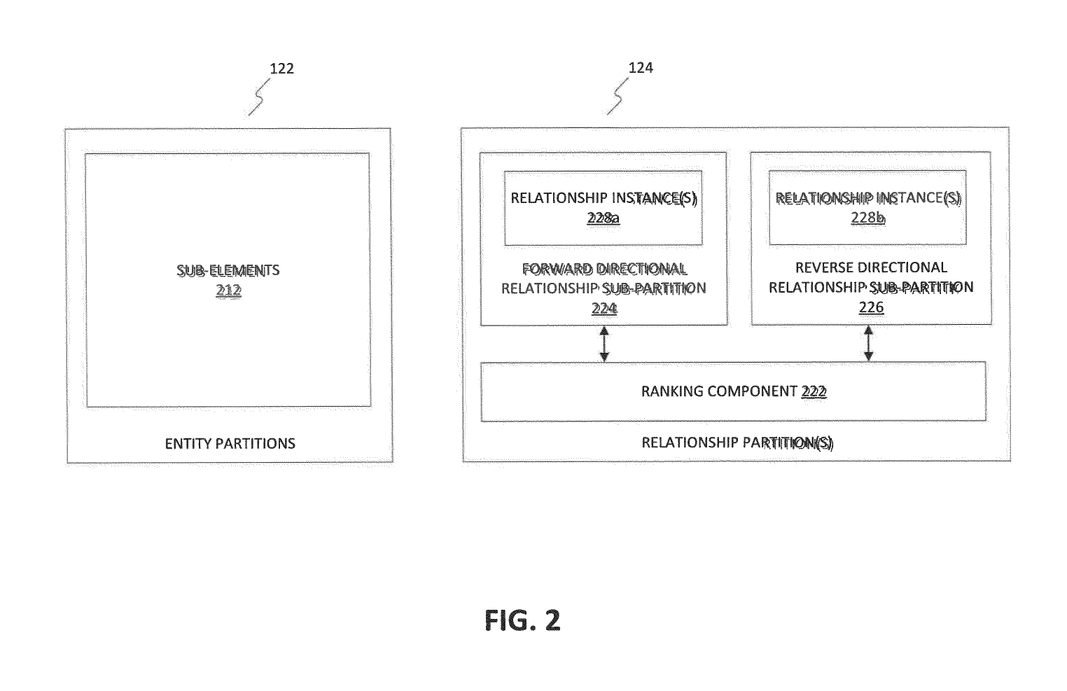

FIG. 2 is a block diagram of example partitions for implementing some embodiments and features of the present disclosure. The arrangement and number of components in system 200 is provided for purposes of illustration. Additional arrangements, number of components, and other modifications may be made, consistent with the present disclosure.

By way of example, entity partitions 122 may be used to store sub-elements 212. Sub-elements 212 may be assigned to an entity partition 122 based on a sub-element type. For example, a sub-element 212 may be an attribute sub-element, a representation sub-element, or a searchable sub-element. An attribute sub-element 212 may be distributed to a shard entity partition 122, a searchable sub-element 212 may be distributed to a shard/sub-shard entity partition 122, and a representation sub-element 212 may be distributed to a segment entity partition 122.

Relationship instances may be distributed to one or more relationship partitions 124. In some embodiments, relationship instances 228a-b may be determined to be bidirectional relationships. Each of the bidirectional relationship instances 228a-b may be distributed among relationship partitions 124 based on a direction of the relationship. For example, a forward directional relationship instance 228a may be distributed to a forward directional relationship sub-partition 224. As another example, a reverse directional relationship instance 228b may be distributed to a reverse directional relationship sub-partition 226.

Once the bidirectional relationship instances 228a-b are distributed to their respective directional relationship sub-partition, a ranking component 222 may rank the relationship instances in each direction relationship sub-partition. For example, relationship instances 228a stored in forward directional relationship sub-partition 224 may be ranked by ranking component 222 according to the universal identifiers associated with the source sub-elements included in the relationship data elements used to determine relationship instances 228a. As another example, relationship instances 228b stored in reverse directional relationship sub-partition 226 may be ranked by ranking component 222 according to the universal identifiers associated with the source sub-elements included in the relationship data elements used to determine relationship instances 228b.

Returning to FIG. 1, in some embodiments, server 150 may include one or more servers configured to communicate and interact with structured data set distribution system 102 and database 160. In some embodiments, server 150 may include structured data set distribution system 102 and/or the functions and methods performed by structured data set distribution system 102. Server 150 may be a general-purpose computer, a mainframe computer, or any combination of these components. In certain embodiments, server 150 may be standalone computing system or apparatus, or it may be part of a subsystem, which may be part of a larger system. For example, server 150 may represent distributed servers that are remotely located and communicate over a communications medium (e.g., the network) or over a dedicated network, for example, a LAN. Server 150 may be implemented, for example, as a server, a server system comprising a plurality of servers, or a server farm comprising a load balancing system and a plurality of servers depending on the entity partitions 122 and relationship partitions 124 produced by structured data set distribution system 102.

Server 150 may be used to store entity partitions 122 and relationship partitions 124 in an IAP digest metadata file. For example, the IAP digest metadata file may be stored on server 150 as an XML file or a protobuf file. Server 150 may also be used to store the structured data that conforms to metadata model 162. For example, the structured data may be stored on server 150 as an XML the or a protobuf file.

Database 160 may include one or more logically and/or physically separate databases configured to store data. The data stored in database 160 may be accessed by servers 150, and received from structured data set distribution system 102, and/or may be provided as input using conventional methods (e.g., data entry, data transfer, data uploading, etc.). The data stored in the database 160 may take or represent various forms including, but not limited to, documents, presentations, textual content, mapping and geographic information, entity data, structured data that conforms to a metadata model, digest metadata files, extensible markup language (XML) files, protobuf (Out) files, and a variety of other electronic data, or any combination thereof. In some embodiments, database 160 may comprise an index database.

In some embodiments, database 160 may be implemented using a single computer-readable storage medium. In some embodiments, database 160 may be maintained in a network attached storage device, in a storage area network, or combinations thereof, etc. Furthermore, database 160 may be maintained and queried using numerous types of database software and programming languages, for example, XML, protobuf, SQL, MySQL, IBM DB2®, Microsoft Access®, PERL, C/C++, Java®, etc. Although FIG. 1 shows database 160 associated with server 150, database 160 may be a standalone database that is accessible via the network or database 160 may be associated with or provided as part of a system or environment that may be accessible to structured data set distribution system 102 and/or other components.

Database 160 may be used to store entity partitions 122 and relationship partitions 124 in addition to an IAP digest metadata file. For example, the IAP digest metadata file may be stored in database 160 as an XML the or a protobuf file. Database 160 may also be used to store the structured data that conforms to metadata model 162. For example, the structured data may be stored in database 160 in a format determined by the compiler plugins. As an example, the compiler plugins may specify the structured data to be stored as an XML file or a protobuf file.

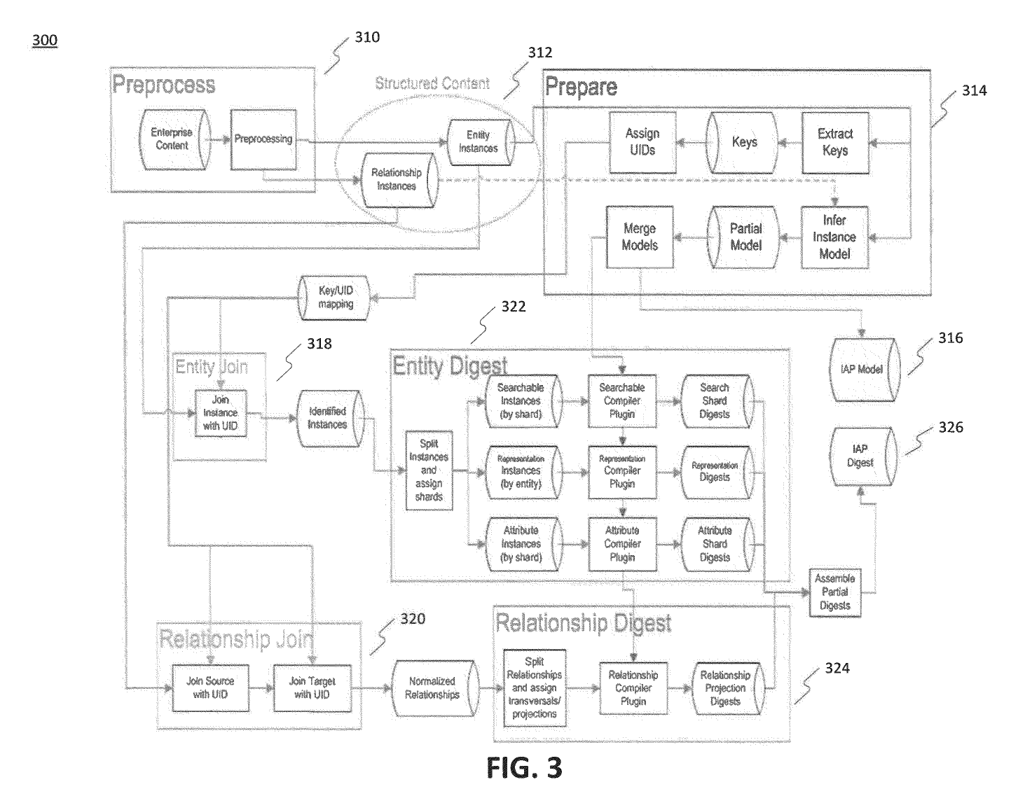

In certain embodiments, IAP content compilation may be performed in a series of phases. An exemplary embodiment of the compilation process is shown in FIG. 3. The compilation process 300 may comprise a Preprocess phase 310, a Prepare phase 314, an Entity Join phase 318, a Relationship Join phase 320, an Entity Join phase 322, and a Relationship Digest phase 324. Data may start in Preprocess phase 310 and then flow to the Prepare phase 314, Entity Join phase 318 and Relationship Join phase 320, and Entity Digest phase 322 and Relationship Digest phase 324. Preprocess phase 310 may convert eclectic Enterprise Content into a normalized form referred to as Structured Content 312. Preprocessing varies between Enterprise Content domains. Preprocess phase 310 may even be omitted if the compiler input is provided as Structured Content 312.

In the exemplary embodiment shown in FIG. 3, Prepare phase 314 performs two major tasks: 1) assign a sequential UID to each entity instance, and 2) infer a model of the data by recording significant aspects of the structured contents. The model becomes part of the output digest's metadata. Entity Join phase 318 and Relationship Join phase 320 unite the full structured content 312 instance data with its assigned UID from Prepare phase 314. Entity Digest phase 322 and Relationship Digest phase 324 split the data into distinct sections (shards, sub-shards, segments, transversals) and pass it to plugin modules which store it in predetermined directories within an output IAP digest 326. The plugin modules are fully configurable and are paired with server side plugins. Thus, the interpretation and format of the content data is determined completely by the application using the compiler. The number of sections is controlled by a configuration parameter.

### Example Data Flow

To help clarify the data flow through the compiler, the following example is provided. Two entities, doc and author, and one relationship named authoredby are used. Searchable content includes an accession number (an), abstract, and author information. Representation is illustrated as a more complete, displayable content of the document. Preprocess phase 310 is omitted from the example in order to focus on the compilation. The compiler is configured to produce 2 shards for doc, 1 for author. The number of shards also correlates to number of representation segments and (indirectly) the number relationship transversals. One sub-shard for both entities is assumed, e.g. no sub-sharding. Sub-sharding has no impact on representation segments. The present example employs three doc entities, three author entities and four relationships. As shown below, there may be multiple relationships of one document with two authors. The content may be contained within the Hadoop key portion of the records, the values are empty.

entity doc

key: 0012700
searchable solr

| | |
|---|---|
| an: | 1957:12 |
| abstract: | Get rich schemes for greedy ducks. . . |
| author: | Daffy_Duck |

| | |
|---|---|
| attribute lang: | English |
| attribute pubyear: | 1957 |

representation full

I may be a coward but I'm a greedy little coward. . .

entity doc

key: 0012300
searchable solr

| an: | 1953:45 |
|---|---|
| abstract: | Techniques for hunting ducks and cwazy |
| | wabbits. . . |
| author: | Elmer_Fudd |

| | |
|---|---|
| attribute lang: | English |
| attribute pubyear: | 1953 |

representation full

Be vewy vewy quiet, I'm hunting. . .

entity doc

key: 0012800
searchable solr

| | |
|---|---|
| an: | 1958:1 |
| abstract: | Tales of out-smarting a silly hunter. . . |
| author: | Bugs_Bunny |
| author: | Daff_Duck |

| | |
|---|---|
| attribute lang: | English |
| attribute pubyear: | 1958 |

representation full

What's up doc? I asked Mr. Fudd. . .

entity author

key: Elmer_Fudd
representation display: Fudd, Elmer J.

entity author

key: Daffy_Duck
representation display: Duck, Daffy

entity author

key: Bugs_Bunny
representation display: Bunny, Bugs

relationship authoredby

source: doc-0012700
target: author-Daffy_Duck

relationship authoredby

source: doc-0012300
target: author-Elmer_Fudd

relationship authoredby

source: doc-0012800
target: author-Bugs_Bunny

relationship authoredby

source: doc-0012800
target: author-Daffy_Duck

UID assignments are created as standard MapReduce records (denoted as key->value).

author-Bugs_Bunny −> uid: 0
author-Daffy_Duck −> uid: 1
author-Elmer_Fudd −> uid: 2
doc-0012300 −> uid: 0
doc-0012700 −> uid: 1
doc-0012800 −> uid: 2

The IAP Model output may be created as an XML and/or protobuf (.pbuf) file aside from the MapReduce record flow. The model is built up from the structured content—if a certain element from the data does not already exist in the model it is added. The following is an abbreviated XML depiction.

<iap-model>

<entity name=“author”>

<representation name=“display”>

<entity name=“doc”>

<attribute name=“lang”>

<bin name=“English”>

<attribute name=“pubyear”>

<bin name=“1953”>

<bin name=“1957”>

<bin name=“1958”>

<searchable name=“solr”>
<representation name=“full”>

<relationship name=“authoredby” source=“doc” target=“author”>

As shown in FIG. 3, in Entity Join phase 318, the UID assignments (i.e. 0, 1, 2) from Prepare phase 314 are attached (as Hadoop keys) to the complete entity instances (as values). It's abbreviated here for brevity.

author-0 −> Bugs_Bunny-<entity data>
author-1 −> Daffy_Duck-<entity data>
author-2 −> Elmer_Fudd-<entity data>
doc-0 −> 0012300-<entity data>
doc-1 −> 0012700-<entity data>
doc-2 −> 0012800-<entity data>

Similarly, in Relationship Join phase 320, the UID assignments from Prepare phase 314 are attached to both source and target entity keys. The entire relationship instance is stored as a Hadoop key and the Hadoop value is empty. The relationship instances are sorted by target UID merely as a side effect of the implementation. There may not be a relationship for every UID (unlike this example).

doc-2-0012800 authoredby author-0-Bugs_Bunny −> _{—}
doc-1-0012700 authoredby author-1-Daffy_Duck −> _{—}
doc-2-0012800 authoredby author-1-Daffy_Duck −> _{—}
doc-0-0012300 authoredby author-2-Elmer_Fudd −> _{—}

In Entity Digest phase 322, the data to be digested is not written to the output through normal MapReduce channels but is presented to the compiler plugins which have exclusive control over how the data is formatted. The compiler does specify the digest section directory into which a digest section is to be written. The plugins don't explicitly get the UIDs; they're implied by the order in which the records are presented. Section assignments are determined by the UID modulo divided by the number of sections.

entities/author/representations/display/segments/0/:
(via representation ‘display’ plugin)

Bunny, Bugs
Duck, Daffy
Fudd, Elmer J.

Notice that because there are two shards, shard 0 gets entries for UID 0 and 2, shard 1 gets the entry for UID 1.

entities/doc/shards/0/attributes/:
(via attribute plugin)

lang: English
pubyear: 1953,1958

entities/doc/shards/1/attributes/:
(via attribute plugin)

lang: English
pubyear: 1957

entities/doc/shards/0/searchable/solr/sub-shards/0/:
(via searchable ‘solr’ plugin)

. . . Techniques for hunting ducks and. . .
. . . Tales of out-smarting a silly hunter. . .

entities/doc/shards/1/searchable/solr/sub-shards/0/:
(via searchable ‘solr’ plugin)

. . . Get rich schemes for greedy ducks. . .

entities/doc/representations/full/segments/0/:
(via representation ‘full’ plugin)

Be vewy vewy quiet, I'm hunting. . .
What's up doc? I asked Mr. Fudd. . .

entities/doc/representations/full/segments/1/:
(via representation ‘full’ plugin)

I may be a coward but I'm a greedy little coward. . .

In Relationship Digest phase 324, the data to be digested is not written to the output through normal MapReduce channels but is presented to the compiler plugins which have exclusive control over how the data is formatted. The compiler specifies the directory into which a digest section is to be written as “relationships/source.relationship.target/transversals/sourceshardtargetshard/direction”. Note that the source/target ordering in the path name is the same regardless of direction. The forward plugin instance gets entries ordered by source then target UID, reverse plugin gets entries ordered by target then source. Only one relationship is used in this example so all the records would be digested via a doc.authoredby.author plugin. The plugins get both source UID and target UID because they may be repeated or contain gaps

relationships/doc.authoredby.author/transversals/0.0/forward/:

doc-0-0012300 authoredby author-2-Elmer_Fudd
doc-2-0012800 authoredby author-0-Bugs_Bunny
doc-2-0012800 authoredby author-1-Daffy_Duck

relationships/doc.authoredby.author/transversals/0.0/reverse/:

doc-2-0012800 authoredby author-0-Bugs_Bunny
doc-2-0012800 authoredby author-1-Daffy_Duck
doc-0-0012300 authoredby author-2-Elmer_Fudd

relationships/doc.anthoredby.author/transversals/1.0/forward/:

doc-1-0012700 authoredby author-1-Daffy_Duck

relationships/doc.authoredby.author/transversals/1.0/reverse/:

doc-1-0012700 authoredby author-1-Daffy_Duck

IAP Digest 326 may be a metadata file that describes the structure and content of the digest data. Following is an abbreviated XML depiction. Note that it contains a direct association with a model metadata file. The path data (shown in red) is always relative to its parent's path. Each entry corresponding to a digest section includes checksum data to illustrate that aggregate data is generated for each plugin output

<iap-digest model=″iap-model.xml″>

<entity-digest name=″author″ path=″entities/author/″>

<representation-digest name=″display″ path=″representations/display/″>

<segment-digest number=″0″ path=″segments/0/″ checksum=″38763917″>

<entity-digest name=″doc″ path=″entities/doc/″>

<shard-digest number=″0″ instancies=″2″ path=″shards/0/″>

<attribute-digest path=″attributes/″ checksum=″93618342″>

<searchable-digest-group name=″solr″ path=″searchables/solr/″>

<searchable-digest number=″0″ path=″sub-shards/0/″ checksum=″83410032″>

<shard-digest number=″1″ instances=″1″ path=″shards/1/″>

<attribute-digest path=″attributes/″ checksum=″37645982″>

<searchable-digest-group name=″solr″ path=″searchables/solr/″>

<searchable-digest number=″0″ path=″sub-shards/0/″ checksum=″76310932″>

<representation-digest name=″full″ path=″representations/full/″>

<segment-digest number=″0″ path=″segments/0/″ checksum=″72338412″>
<segment-digest number=″1″ path=″segments/1/″ checksum=″57421928″>

<relationship-digest name=″authoredby″ path=″relationships/doc.authoredby.author/”

source=″doc″ target=″author″>

<transversal-digest sourceShard=″0″ targetShard=″0″ path=″transversals/0.0/″>

<projection-digest direction=″FORWARD″ path=″forward/″ checksum=″49876234″>
<projection-digest direction=″REVERSE″ path=″reverse/″ checksum=″78941035″>

<transversal-digest sourceShard=″1″ targetShard=″0″ path=″transversals/1.0/″>

<projection-digest direction=″FORWARD″ path=″forward/″ checksum=″36109537″>
<projection-digest direction=″REVERSE″ path=″reverse/″ checksum=″66284529″>

### Detailed Data Row

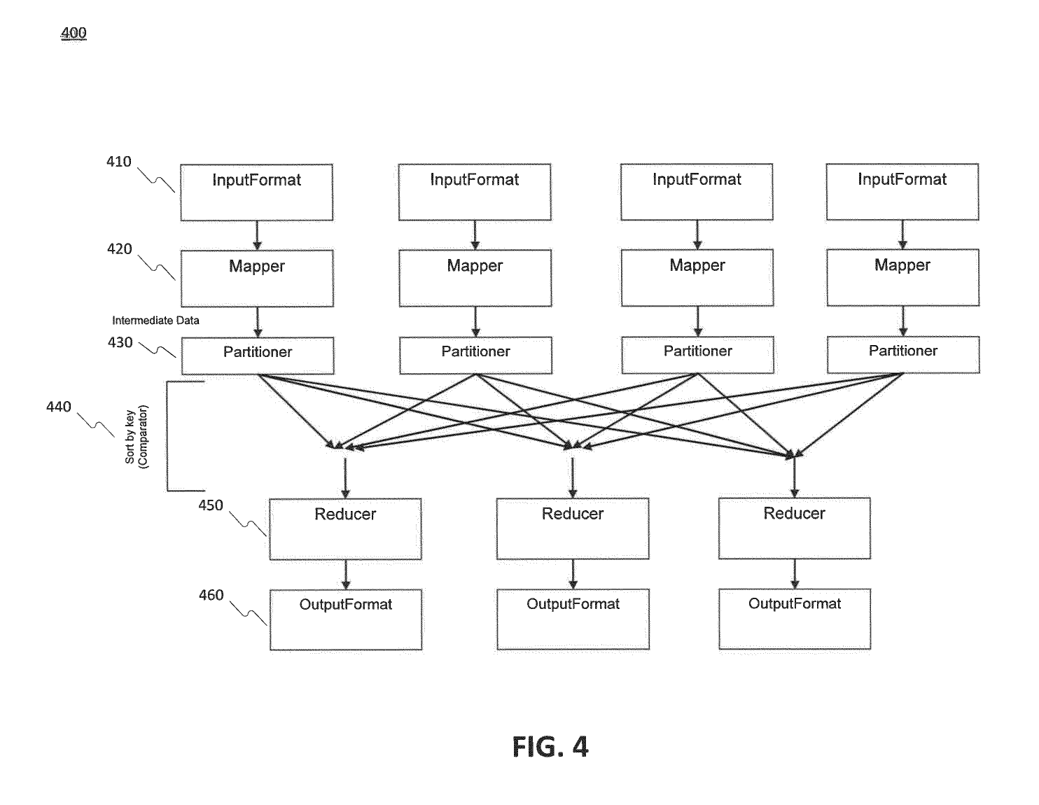

Each compiler phase comprises a set of Hadoop mapper and reducer tasks. FIG. 4 illustrates an exemplary MapReduce architecture 400. The quantity of mappers 420 is typically determined by Hadoop based upon the input data size. The quantity of reducers 450 is specified by the application using Hadoop, e.g. the IAP code. The technique for doing so depends upon the nature of the MapReduce task.

The main components provided to Hadoop which define the MapReduce behavior may be as follows. InputFormat 410 controls how and where to read input records. Mapper 420 converts records into a more useful form for the reducer. That may involve ignoring input records, converting to a different type, expanding to multiple output records or some combination. Partitioner 430 determines which reducer 450 is to receive the record. The number of partitions 430 corresponds to the number of reducers 450. Comparator 440 defines the sort order of records for each reducer 450 based upon record key. Reducer 450 receives groups of records which have equivalent keys (as defined by the Comparator 440). It may consolidate adjacent records, convert them, expand them, or some combination. Its output is often the input to the next MapReduce phase. Grouper is similar to the Comparator but defines how reducer records are grouped together. OutputFormat 460 controls how and where to write output records

A common technique used within the MapReduce framework is to inject auxiliary records into the content data flow. The records can then be sorted and grouped by the comparators 440 in such a way that the auxiliary data is either aggregated or adjacent to its pertinent content for easy processing by a reducer 450. Another technique is to segregate records with an OutputFormat 460 where they can be selected downstream by an InputFormat 410. Both techniques may be concurrently used.

Metadata which is global in nature is written aside from the Hadoop record flow, as with the model data from the Prepare phase (e.g., Prepare phase 314, FIG. 3), where it may be read by downstream phases. Since this data is outside of Hadoop's processing domain, special handling is required to locate data files and possibly merge the outputs of multiple processes.

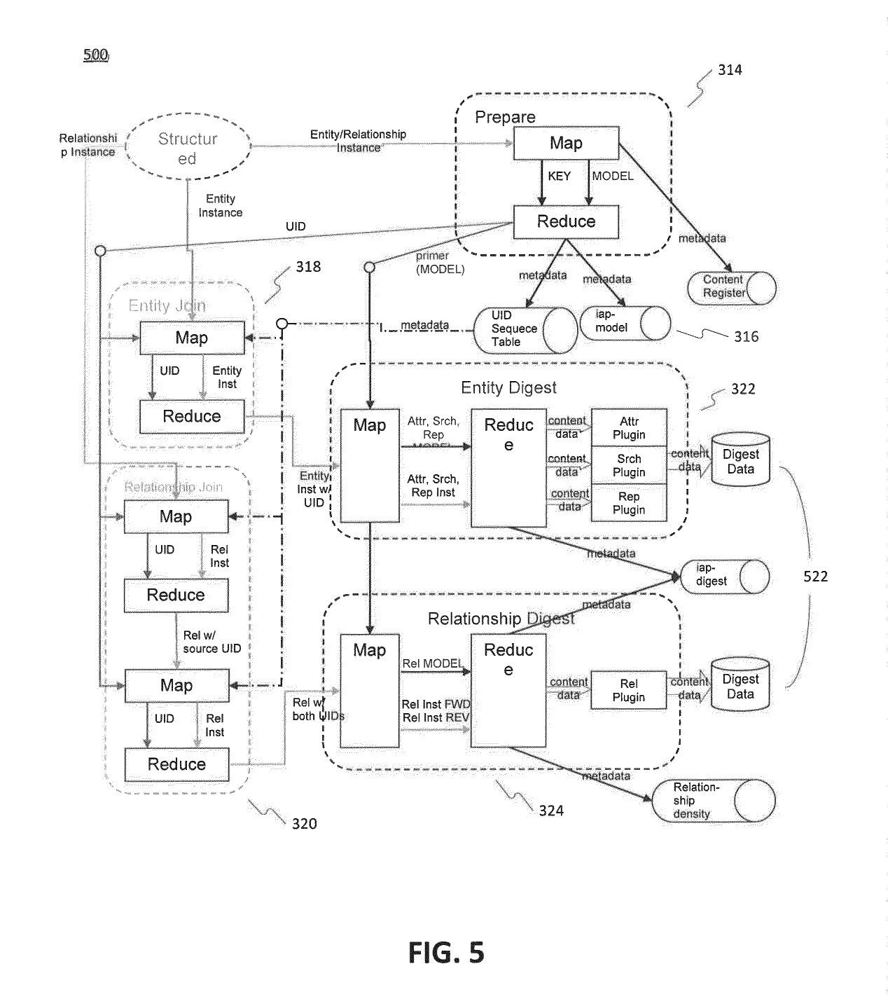

FIG. 5 provides an example data flow diagram 500 including the types of data that flow between the phases including the MapReduce intermediate data. The Prepare phase's 314 primary output comprises records which associate entity keys with an entity specific UID. Reducer input is sorted in ascending entity key order which ultimately determines the record order in the Data Digest 522. A plugin can be configured to override the default ordering. Allocating one reducer per entity to assign sequential UIDs would result in a significant performance bottleneck if any entity contains many instances. Instead, the entity keys are partitioned according to a total ordering across all entities and the task is configured to use all available reducer slots in the cluster. Each reducer assigns a relative UID and records information regarding record counts in a UID Sequence Table. That information is used by downstream Entity Join phase 318 and Relationship Join phase 320 mappers to assign absolute UIDs. The total ordering is accomplished via a Hadoop utility class (TotalOrderPartitioner) which samples the input data to establish evenly distributed partitions. Prepare phase 314 is responsible for producing the lap-model 316 metadata file. The mapper injects inferred MODEL metadata records into the intermediate data which is routed to a single reducer to build the file. In conjunction with building iap-model 316, a primer output is produced which contains MODEL records. It is used by Entity Digest phase 322 and Relationship Digest phase 324 to assure that every configured output digest section is established if the structured content is too sparse to include each. A Content Register metadata the containing entity record counts is created by the mapper. The information is used to configure the number of reducers for the Join phases and is also available for human consultation.

Regarding Entity Join phase 318 and Relationship Join phase 320, there are three MapReduce tasks which join UIDs to content data. The strategy is to sort the union of content and UID records such that they appear adjacent to each other in the reducers where they can be easily joined. Relationship Join phase 320 employs two MapReduce tasks to join UIDs to the relationship's source then target entity keys because each step requires a different sort order.

Digest output comprises a hierarchy of directories whose structure is controlled by the compiler configuration. The two top-level directories are entities and relationships. Each entity is sectioned according to the number of shards configured and includes an optional attribute and 0 or more searchables. Representations are sectioned by segments, the quantity of which is equal to the number of shards. Searchables are further sectioned by sub-shards in order to add a level of parallelism for managing server search performance without impacting representation retrieval. Each relationship can be thought of as a two-dimensional grid of transversals in which the dimensions are dictated by the number of shards configured for the associated source and target entities. A third projection dimension is defined by the relationship directions forward and (optional) reverse.

During Entity Digest phase 322, the mapper splits entity instances into attribute, searchable and representation instances and assigns each to a section (shard, shard/sub-shard and segment respectively) based upon the UID and the compiler configuration. A reducer is allocated for each digest section and receives all the records for that section as one group in UID order. This is accomplished via a very specialized set of Partitioner, Comparator and Grouper classes. Each reducer establishes the section directory then invokes the appropriate plugin to ‘digest’ the instance data. The plugin is in control of writing the data, its sister server plugin will eventually be invoked to read it. The plugin output can be packaged (optional) into a single file per digest section in order to improve digest distribution efficiency. A checksum is also computed on the output and stored in the metadata. The mapper injects a MODEL record for each configured digest segment as derived from the Prepare phase's primer output. The MODEL records get routed to the reducers along with the instance records but are not digested; they simply assure the digest segment gets created. While processing instance records, the reducers also assemble the lap-digest metadata information for each digest segment that is ultimately merged into the final lap-digest.

The operation of Relationship Digest phase 324 closely parallels that of the Entity Digest phase 322. The mapper assigns relationship instances to a transversal based upon the source and target UIDs and the number of shards configured for the associated entities and the projection direction. Reverse projections retain the same source and target entity information as the forward projection but are interpreted backwards. A reducer is allocated for each transversal projection and receives all the records for that projection as one group in source/target UID order for the forward/reverse direction respectively. The same plugin, primer MODEL and lap-digest assembly employed by Entity Digest phase 322 applies here. An accounting of relationship count per projection statistics is written to a series of XML files under a ‘reldensity’ subdirectory in the digest output. It is intended for use for server configuration and capacity planning and is not currently used by any other software packages.

A Sampler phase is an optional phase, which if configured, is inserted before the Prepare phase to select just a sample of the full structured content to produce smaller digests for server performance testing—the Sampler phase is not shown in FIG. 5. Activating the Sampler phase triggers a different data flow among the phases that read the Structured Content. In practice, the Sampler phase is lightly used because it is impossible to control entity count to relationship count ratios. Instead, specially designed Preprocess phases (e.g., Preprocess phase 310, FIG. 3) were used. Sampler phases should not be confused with the sampler classes used in the Prepare phase in conjunction with total order partitioning.

### Operation Details

Hadoop task management may be in terms of “Flows” using the Cascading data processing framework, which invokes the Hadoop tasks in an orderly way with optimal parallelism. Cascading connects Hadoop tasks together dynamically by virtue of the tasks' configured input and output paths, called “source” and “sink” in Cascading terminology.

Structured Content (e.g., Structured Content 312, FIG. 3) input can be in either XML or protobuf format. A command line option informs the compiler which to expect. For efficiency, the remainder of the inter-phase Hadoop traffic is formatted as protobuf records in Hadoop sequence files. Intermediate metadata files are also encoded as protobuf files, however, the final metadata information is written as protobuf and XML files. Hadoop performance can be significantly improved by using a RawComparator which can compare encoded records rather than first deserializing them. However, since the traditional Java Comparator which operates on instantiated objects is still needed, one is required to implement the comparator logic twice. In order to avoid maintaining two comparators, the ProtobufAccessor abstraction allows an implementation of comparator logic to operate on either target. A complementary ProtobufManipulator abstraction provides a similar means of modifying protobuf contents which permits code consistency. Therefore, the compiler phase code contains relatively few examples of ‘traditional’ protobuf manipulation.

The compilation process may be controlled using configuration files. The compiler configuration may set forth: Structured Content data names expected (e.g. entity name, searchable name); relationships expected; number of digest segments to be generated for each aspect of the data; plugins (beans) to be used for each digest segment; type of packaging for each segment; input paths; output paths; and a Structured Content sampler (optional). The IAP compiler may be executed with options specifying the compiler configuration file, input format, phases to be run or skipped, or to execute a dry run.

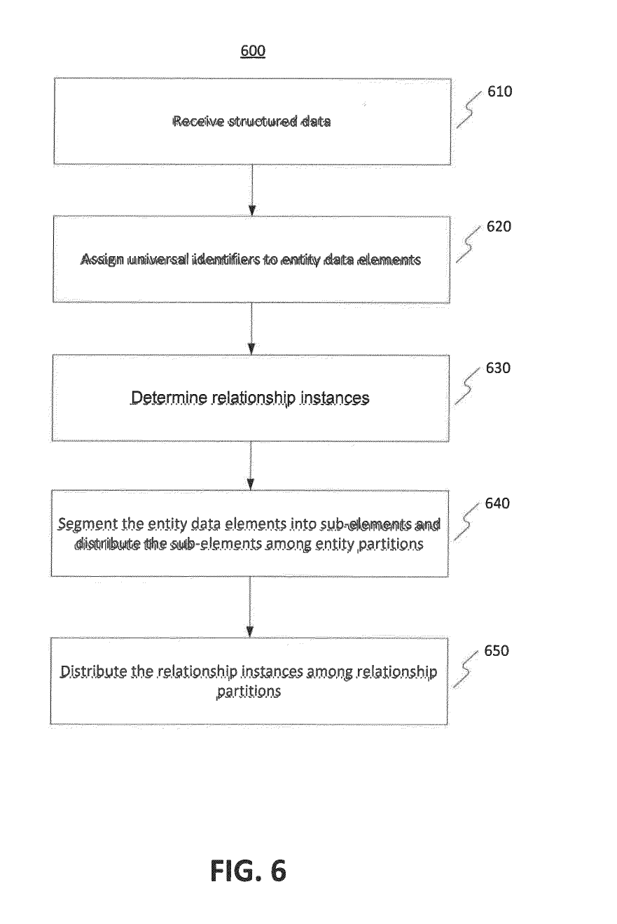

FIG. 6 depicts a flowchart of an example method 600, consistent with some embodiments of the present disclosure. Method 600 may be implemented for distributing structured data sets. In some embodiments, method 600 may be implemented as one or more computer programs executed by a processor. For example, method 600 may be implemented by a system (e.g., structured data set distribution system 102 having one or more processors 106 or structured data set distributors 110 executing one or more computer programs stored on a non-transitory computer readable medium, both of FIG. 1), or a server (e.g., server 150 having one or more processors executing one or more computer programs stored on a non-transitory computer readable medium, FIG. 1). In some embodiments, method 600 may be implemented by a combination of structured data set distribution system 102, server 150, and a database (e.g., database 160, FIG. 1).

As shown in FIG. 6, example method 600 may include receiving structured data (e.g., Structured Content 312, FIG. 3) at 610. The structured data may be received at, for example, processor 106 or structured data set distributor 110 of structured data set distribution system 102 as shown in FIG. 1. The structured data may be comprised in any form of input. For example, the structured data may include text, images, audio, videos, chemical formulas and structures, or any combination thereof.

Further, the structured data may include a plurality of entity data elements and one or more relationship data elements. The plurality of entity data elements may be categorized as any number of entity data element types. For example, an entity data element may be categorized as one of a “doc” element type or an “author” element type.

Method 600 may include assigning universal identifiers to the entity data elements at 620. In some embodiments, the processor or an assigning component (e.g., assigning component 114, FIG. 1) may be configured to assign universal identifiers to the entity data elements. For example, the universal identifiers may be numerical identifiers that are assigned in sequential order to entity data elements or instances. The assigning component or processor may thus assign the numerical identifiers sequentially to each entity data element of an entity data element type. As an example of the above, the structured data may include three “author” entity data elements and three “doe” entity data elements. The assigning component or processor may assign numerical universal identifiers 0-2 to the three “author entity data elements (e.g., author-0, author-1 and author-2) and numerical universal identifiers 0-2 to the three “doc” entity data elements (e.g., doc-0, doc-1, and doc-2).

Method 600 may include determining relationship instances at 630. In certain embodiments, a processor or determining component (e.g., processor 106 or determining component 116, both of FIG. 1) may determine one or more relationship instances (e.g., relationship instances 208a-b, FIG. 2). A relationship instance may correspond to one or more relationships between the assigned universal identifiers according to the one or more relationship data elements. The one or more relationship data elements may include a source sub-element and a target sub-element. The source and target sub-elements may be used to define a relationship or an association between two entity data elements. For example, a relationship data element that contains a source sub-element “doc” and a target sub-element “author” may define the relationship “doc authoredby author” which associates a document with the author of the document.

Method 600 may include segmenting the entity data elements into sub-elements at 640. A processor or segmenting component (e.g., processor 106 or segmenting component 118, both of FIG. 1) may segment the entity data elements into sub-elements elements having types. The assigning component or processor may also be configured to assign universal identifiers to the sub-elements. For example the sub-elements may be assigned numerical universal identifiers.

A sub-element of an entity data element may have one of various sub-element types including, for example, an attribute sub-element, a representation sub-element, or a searchable sub-element. An “attribute” may be used to categorize sub-elements across a facet with a reasonably bounded set of values. As an example, an attribute sub-element may be a language in which a document was written, a publication year of the document, an author of the document, or any other attributes known in the art. A representation sub-element may comprise parts of structured content retrievable for an entity data element. A searchable sub-element may refer to portions of structured content that can be indexed for efficient searching.

Further at 640, the sub-elements may be distributed among entity partitions by the processor or a distributing component (e.g., distributing component 120, FIG. 1). An entity partition may include various types of database partitions including database shards, sub-shards, or segments. The distributing component or may distribute the sub-elements among entity partitions based (or according to) the sub-element types or the numerical universal identifiers assigned to the sub-elements. As an example, an attribute sub-element may be distributed to a shard entity partition, a searchable sub-element may be distributed to a shard/sub-shard entity partition, and a representation sub-element may be distributed to a segment entity partition.

Method 600 may include distributing the relationship instances among relationship partitions at 650. The processor or the distributing component may distribute the determined relationship instances among one or more relationship partitions. A relationship partition, (e.g., relationship partition 124, FIG. 1), may store relationship instances that define a relationship transversal based on source and target universal identifiers.

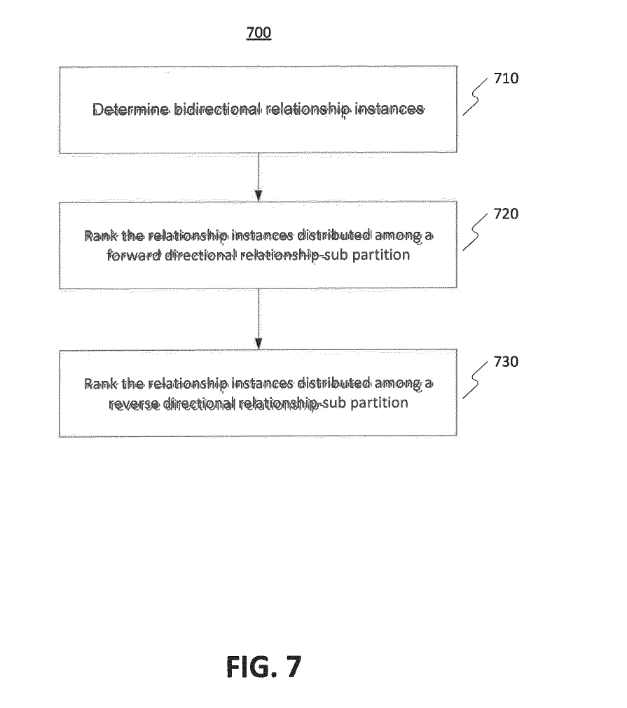

FIG. 7 depicts a flowchart of an example method 700, consistent with some embodiments of the present disclosure. Method 700 may be implemented for distributing relationship instances among relationship partitions. In some embodiments, relationship instances may be determined to be bidirectional relationships at 710. Each of the bidirectional relationship instances may be distributed among relationship partitions based on a direction of the relationship. For example, a forward directional relationship instance may be distributed to a forward directional relationship sub-partition. As another example, a reverse directional relationship instance may be distributed to a reverse directional relationship sub-partition.

Method 700 may include ranking the relationship instances at 720 and 730. Once the bidirectional relationship instances are distributed to their respective directional relationship sub-partition, the processor or a ranking component (e.g., ranking component 222, FIG. 2) may rank the relationship instances in each direction relationship sub-partition. For example, relationship instances stored in a forward directional relationship sub-partition may be ranked by the processor or ranking component according to the universal identifiers associated with the source sub-elements included in the relationship data elements used to determine the relationship instances. As another example, relationship instances stored in a reverse directional relationship sub-partition may be ranked by the processor or ranking component according to the universal identifiers associated with the source sub-elements included in the relationship data elements used to determine the relationship instances.

### IAP Server

The IAP Server provides search/retrieval functionality plus navigation and summarization across many entity data types, search methods, attributes, and relationships. The IAP Server may be a stateless, distributed system used to search and explore compiled structured content. It may run on, for example, a single computer or a cluster computer. During startup, the IAP Server reads an IAP Digest and uses its product model, as well as its alpha and beta sharding information, to create an algorithm plan. The algorithm plan may then be mapped onto an execution topology which in turn may be mapped onto the available physical resources. After initialization, the IAP Server may comprise a multi-node, multi-process, multi-threaded system. The algorithm plan may also include bidirectional communication channels. The mapping of logical onto physical resources exploits multiple communication channel implementations and statistically balances resource consumption for all client requests. By reviewing the compiled IAP Digest, the IAP Server can create the appropriate processes and the relationships between them (or channels between processes) in order to satisfy user search queries.

The channels may allow asynchronous message-orientated communication between IAP Server engines. The channels may be created at the startup (or recovery) of the IAP Server engines, and may process requests as first-in first-out (FIFO)) or bidirectional. As such, the channels provide an internal framework for modeling and establishing a constellation of engines on a cluster of servers that are connected.

Because it is stateless, multiple IAP Server instances using copies of the same IAP Digest may be combined to provide load balancing and fault tolerance. This is accomplished using a router mesh at a single site. The router also facilitates seamless product migration to new versions of content and/or software. When the technique of instantiation is used to create the entire product, multiple product instances running at different geographic sites may be architected to provide business continuity.

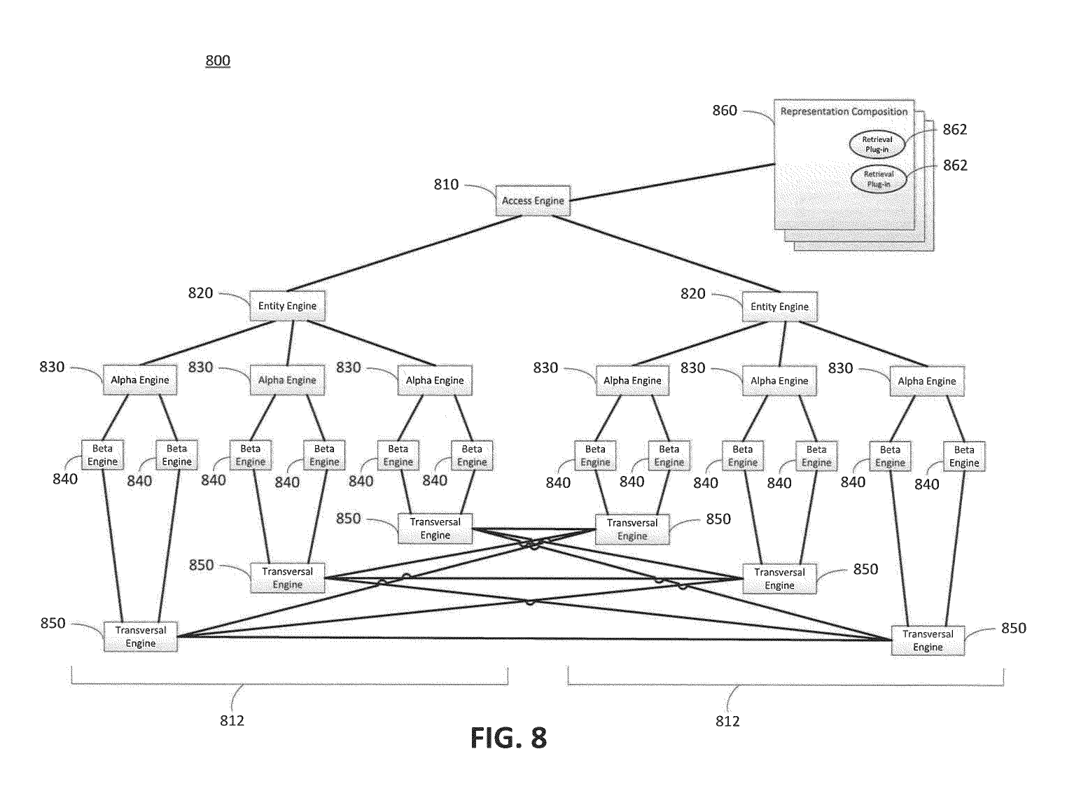

FIG. 8 illustrates an example of an IAP Server component framework 800 in deployment. In some embodiments, the IAP Server and/or its functions may be implemented by server 150 of FIG. 1. In the example illustration, each engine allows for task decomposition, and represents one or more threads that will become part of an execution topology of processes running in memory regions on nodes. The topology represented in FIG. 8 is an example and it is to be understood that the IAP Server component framework 800 may repeat and rearrange the various arrangements as shown so as to be able to process multiple requests simultaneously.

In some embodiments, IAP Server component framework 800 may include one or more access engines 810. Access engine 816 may manage access server plug-ins and synchronize access to execution cores 812. Further, access engine 810 insulates clients from internal IAP component framework protocols and insulates execution cores 812 from potentially slow client I/O. Access engine 810 also composes and retrieves answer representations.

In some embodiments, IAP Server component framework 800 may include one or more entity engines 820. Entity engine 820 represents a single entity data element type, and manages entity partitions such as alpha shards. Further, entity engine 820 coordinates requests for attribute filtering, search summarization, and projections among partitions. Entity engine 820 further collates partial summaries from all alpha shards and merges and sorts query answers with a priority queue.

In some embodiments, IAP Server component framework 800 may include one or more alpha engines 830. Alpha engine 830 represents a single entity data element type, and manages entity partitions such as beta shards. Further, alpha engine 830 coordinates requests for attribute filtering, search summarization, and projections among partitions. Alpha engine 830 further collates partial summaries from all beta shards and merges and sorts query answers with a priority queue.

In some embodiments, IAP Server component framework 800 may include one or more beta engines 840. Beta engine 840 may coordinate requests by constraining query answers. For example beta engine 840 may constrain a query answer to an attribute sub-element or a searchable sub-element. Beta engine 840 may also combine query results from multiple constraint sources and coordinate summarization of search query requests.

In some embodiments, IAP Server component framework 800 may include one or more transversal engines 850. Transversal engine 850 may represent a single partition of relationship data between two partitions. For example, transversal engines 850 may share relationship data of two of beta partitions 840. Transversal engine 850 may also map source sub-elements to target sub-elements contained in a relationship data element and accumulate scores and incident relationship frequencies.

Transversal engine 850 may represent a mixed two-dimensional geometric decomposition of relationship instances. For example, transversal engine 850 may use beta-level data decomposition with alpha-level communication decomposition.

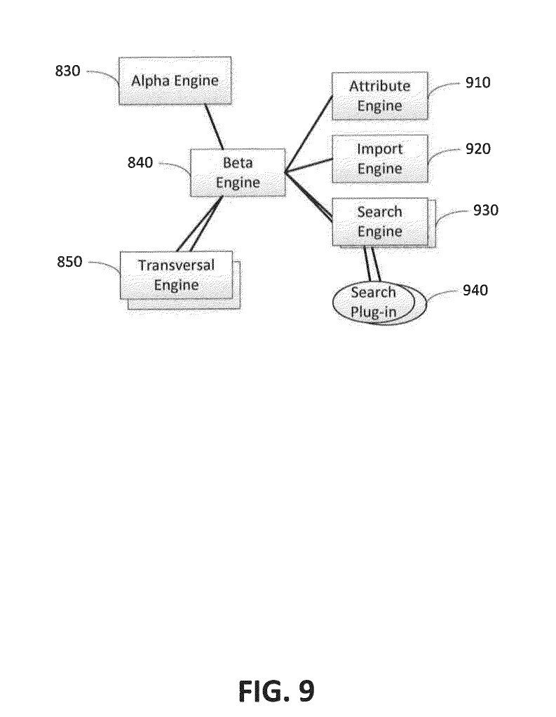

As shown in FIG. 9, beta engines 840 may be connected to attribute engines 910, import engines 920, search engines 930, and transversal engines 850 as necessary to meet the execution requirements for a given IAP Digest. The execution requirements for a given IAP Digest may be determined by the product model's search types, attribute types, importable keys, and relationship types.

Attribute engine 910 may filter and summarize within an entity partition. For example, the attribute engine may return a set of scored answers for a given attribute relevance vector. As another example, an attribute engine may return a set of attribute summary vectors for a given set of scored answers.

At least one search engine 930 may be provided for each search type. Search engine 930 may use a search plug-in 940 to provide search functionality within entity and relationship partitions. For example, one or more search engines 930 may provide search for a beta shard or an optional delta shard. Optional delta sharding may result in multiple search engines 930 per search type, for example, to process-separate non-reentrant code.

Returning to FIG. 8, in some embodiments, IAP Server component framework 800 may include one or more representation compositions 860. Representation composition 860 may operate outside of and/or independent of execution cores 812. Representation composition 860 may coordinate retrieval of entity representations and highlight representations relative to search queries. Further, representation composition 860 may obtain representations for a given entity instance and/or representation sub-element. As an example, retrieval plug-ins 862 may be used by representation composition 860 to highlight representations relative to a given search query.

When the IAP Server is run on a large cluster, one alpha engine may run on each server node for each entity type, and one beta engine may run on each memory region for each entity type. The IAP Compiler and Server use configurable plug-ins to extend many abstract capabilities, including search, such as per-entity type search, and retrieval. Since many implementations are possible, plug-ins may represent a strategy for customizing products, including integrating proprietary software, third-party software, and different vendor technologies. They may be used to manage risk, obsolescence, and innovation. Plug-ins may be reused across different entities and products, often requiring only configuration or possibly the injection of their own plug-ins. Plug-ins may be managed as pairs (one compiler plug-in and one server plug-in), with each pair developed, unit tested, and versioned in isolation. The plug-ins configured for compilation may match the plug-ins used for the online server. The compiler and server plug-ins share information through directories contained within an IAP digest.

The IAP Server also uses a metadata model to process client requests and return valuable information. Clients may send a model request to obtain the product model from a running IAP Server. The returned model may be used to validate client expectations or as a basis for discovery. Products often combine validation of high-level entities/relationships with the discovery of low-level attribute values.

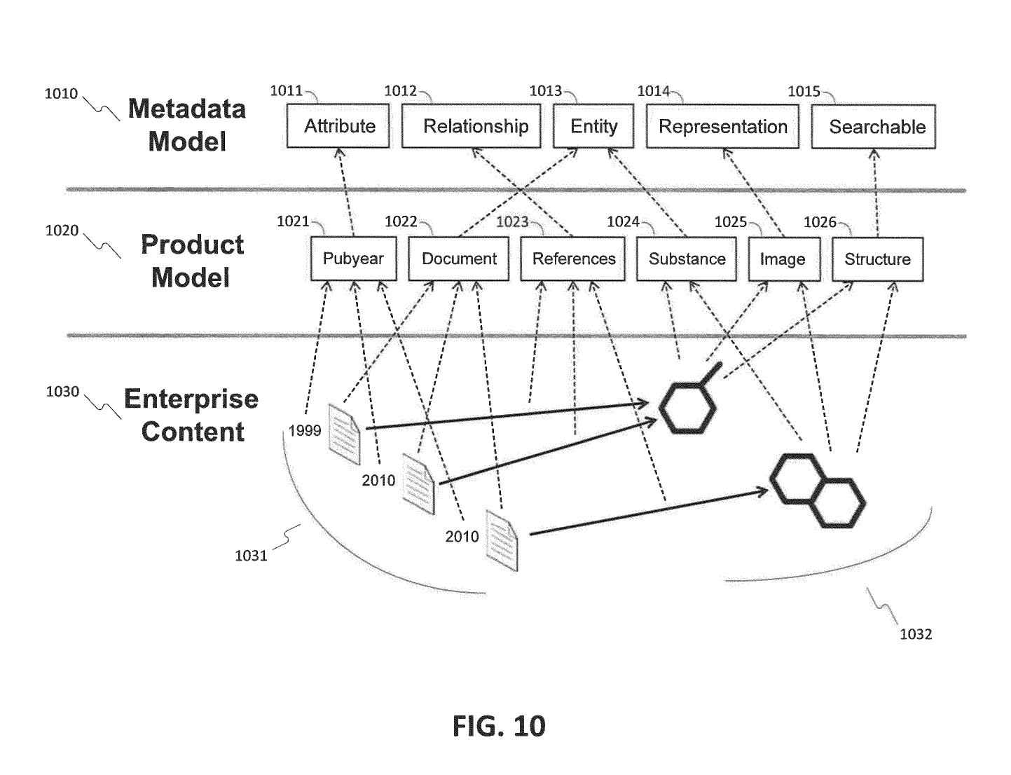

FIG. 10 illustrates an example metadata model used by the IAP Compiler to store structured data and the IAP Server to process client requests and return valuable information. As illustrated in FIG. 10, enterprise content 1030 may be processed into sub-sections that are categorized according to a product model 1020, and then converted into structured content conforming to a metadata model 1010.

As an example, enterprise content 1030 may include one or more published documents 1031 that contain references to registered chemical substances 1032. Various aspects of published documents 1031 and chemical substances 1032 may be classified as a PubYear (i.e., publication year) aspect 1021, document aspect 1022, references aspect 1023, substance aspect 1024, image aspect 1025, and structure aspect 1026 at the product model 1020 level.

Metadata model 1010 may include one or more elements. For example, metadata model 1010 may include an attribute element 1011, a relationship element 1012, an entity element 1013, a representation element 1014, and/or a searchable element 1015. The categorized aspects of published documents 1031 and chemical substances 1032 may be converted into structured content according to the elements of metadata model 1010. For example, document aspect 1022 and substance aspect 1024 may be categorized as entity elements 1011, PubYear aspect 1021 may be categorized as an attribute element 1011 of the document entity element 1013, and substance entity element 1013 may be made searchable by categorizing structure aspect 1024 as a searchable element 1015. Additionally, document and substance entity elements 1013 may be represented by image aspect 1025 if image aspect 1025 is categorized as a representation element 1014.

The majority of client requests may be explore requests. Each explore request may be comprised of one or more entity requests. Each entity request may create a scored answer set of entity instances for a single entity type (different entity requests in the same explore request may create answer sets of the same entity type). Each answer set may be determined by a client-provided constraint stack. Constraint types include, for example, search (performed by a plug-in), filter (clients express relevance per attribute bin; zero excludes an answer), import (keys identify instances), projection (constrains answers to those which are linked via a relationship instance to answers in another previous answer set), and multiple operations (binary AND and OR, unary NOT, and nary custom operations). Clients may compose explore requests that contain multiple entity requests with projection constraints to perform graph search over a constrained combination of entities (nodes) and relationships (edges). Projection constraint scoring options may include, for example, frequency (the total number of links), source score, and link (compiled) scores. An entity request with no constraints matches all entity instances (with a score of one). Multi-dimensional vectors allow answer sets to be expressed succinctly as run-length encoded vectors that include scoring information. A multi-level, cost-based caching strategy may be used to maintain performance when client requests specify (some or all of) the same constraints (plug-ins must provide deterministic answers).

Each entity request may further allow clients to specify one or more summary requests and zero of more window requests. Each summarization request may return the bin frequency distribution data for all the answers in the answer set across an attribute, which may be suitable for displaying one-dimensional histogram. Each window request may return a subset of the answer set, which can be ordered according to score, attributes and/or compile-time orderings where only the top-N scored answers are ordered. N may be configurable and may use O(n log n) time complexity and O(n) space complexity. In some embodiments, the client may specify the offset and length of the subset.

Each answer may include a score, a representation, and optionally, an answer context. The representation may be supplied by the configured retrieval plug-in. The answer context may include, for example, search metadata supplied by the search plug-in, attribute values, and related answers. In other words, the answer context may include a projection from each answer onto a related answer set, where a window is returned and the concept is recursive. The answer context feature may allow clients to efficiently obtain a constrained sub-graph in a single request. Answer context information may be provided to the retrieval plug-in for dynamic content generation, including adding highlighting and navigation links. A combination of projections and answer context requests provides fast multi-dimensional analysis in a single explore request.

The response to an explore request may be streamed back to the client via an event-driven handler. Results may be presented to the client in the order in which they were requested. The size of the answer set and the size of an answer (i.e., its representation) are not limited by the framework. End-to-end flow control is provided.

The IAP Server combines many features into a single low-latency client interaction, including text/chemical substance/reaction search, faceted navigation, multi-dimensional analysis, graph search, answer context for highlighting and navigation, and streaming results.

The features and other aspects and principles of the disclosed embodiments may be implemented in various environments. Such environments and related applications may be specifically constructed for performing the various processes and operations of the disclosed embodiments or they may include a general purpose computer or computing platform selectively activated or configured by program code to provide the necessary functionality. The processes disclosed herein may be implemented by a suitable combination of hardware, software, and/or firmware. For example, the disclosed embodiments may implement general purpose machines that may be configured to execute specialty software programs that perform processes consistent with the disclosed embodiments. Alternatively, the disclosed embodiments may implement a specialized apparatus or system configured to execute software programs that perform processes consistent with the disclosed embodiments.

The disclosed embodiments also relate to tangible and non-transitory computer-readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low level software instructions, such as for example machine code (e.g., such as that produced by a compiler) and/or high level code that may be executed by a processor using an interpreter.

Additionally, the disclosed embodiments may be applied to different types of processes and operations. Any entity undertaking a complex task may employ systems, methods, and articles of manufacture consistent with certain principles related to the disclosed embodiments to plan, analyze, monitor, and complete the task. In addition, any entity associated with any phase of an article evaluation or publishing may also employ systems, methods, and articles of manufacture consistent with certain disclosed embodiments.

Furthermore, although aspects of the disclosed embodiments are described as being associated with data stored in memory and other tangible computer-readable storage mediums, one skilled in the art will appreciate that these aspects may also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

What is claimed is:

1. A computer-implemented system for distributing structured data sets, comprising:
a memory device that stores a set of instructions; and
at least one processor that executes the instructions to:
receive structured data, the structured data including a plurality of entity data elements and one or more relationship data elements;
assign universal identifiers to the entity data elements;
determine one or more relationship instances, the one or more relationship instances corresponding to one or more relationships between the assigned universal identifiers according to the one or more relationship data elements;
segment the entity data elements into sub-elements having types, and distribute the sub-elements among a plurality of entity partitions; and
distribute the determined one or more relationship instances among one or more relationship partitions.

2. The computer-implemented system according to claim 1, wherein the at least one processor further executes the instructions to store the structured data in a database that conforms to a metadata model.

3. The computer-implemented system according to claim 1, wherein the one or more relationship data elements each include a source sub-element and a target sub-element.

4. The computer-implemented system according to claim 3, wherein:
the universal identifiers comprise a plurality of first and second universal identifiers;
the source sub-element corresponds to a first entity data element among the entity data elements and the target sub-element corresponds to a second entity data element among the entity data elements; and
the at least one processor executes the instructions to:
assign a first universal identifier to the first entity data element and a second universal identifier to the second entity data element; and
determine a relationship instance reflecting a relationship between the first universal identifier and the second universal identifier according to the one or more relationship data elements.

5. The computer-implemented system according to claim 3, wherein:
the determined one or more relationship instances are bidirectional relationships; and
each of the one or more relationship partitions includes a forward directional relationship sub-partition and a reverse directional relationship sub-partition.

6. The computer-implemented system according to claim 5, wherein the at least one processor executes the instructions to distribute the relationship instances among the forward directional relationship sub-partition and the reverse directional relationship sub-partition.

7. The computer-implemented system according to claim 6, wherein the at least one processor further executes the instructions to:
rank the determined one or more relationship instances distributed among the forward directional relationship sub-partition according to ones of the universal identifiers associated with the source sub-elements; and
rank the determined one or more relationship instances distributed among the reverse directional relationship sub-partition according to ones of the universal identifiers associated with the target sub-elements.

8. The computer-implemented system according to claim 1, wherein the at least one processor executes the instructions to distribute the sub-elements among the entity partitions based on sub-element type.

9. The computer-implemented system according to claim 8, wherein the sub-element type is one of an attribute sub-element, a representation sub-element, or a searchable sub-element.

10. The computer-implemented system according to claim 1, wherein:
the universal identifiers comprise a plurality of first and second universal identifiers; and
the at least one processor further executes the instructions to assign second universal identifiers to each of the sub-elements.

11. The computer-implemented system according to claim 10, wherein the at least one processor executes the instructions to distribute the sub-elements among the entity partitions based on the second universal identifiers.

12. The computer-implemented system according to claim 1, wherein:
the first universal identifiers are numerical identifiers; and
the at least one processor executes the instructions to assign the numerical identifiers sequentially to each of the entity data elements.

13. The computer-implemented system according to claim 12, wherein
the structured data includes a plurality of entity data element types; and
the at least one processor executes the instructions to assign the numerical identifiers sequentially to each entity data element of an entity data element type.

14. The computer-implemented system according to claim 1, wherein the at least one processor further executes the instructions to store the entity partitions and the one or more relationship partitions along with digest metadata in a file on a server.

15. A method for distributing structured data sets, the method performed by one or more processors and comprising:
receiving structured data, the structured data including a plurality of entity data elements and one or more relationship data elements;
assigning first universal identifiers to the entity data elements;
determining one or more relationship instances, the one or more relationship instances corresponding to one or more relationships between the assigned universal identifiers according to the one or more relationship data elements;
segmenting the entity data elements into sub-elements having types, and distributing the sub-elements among a plurality of entity partitions; and
distributing the determined one or more relationship instances among one or more relationship partitions.

16. The method according to claim 15, further comprising storing the structured data in a database that conforms to a metadata model.

17. The method according to claim 15, wherein the one or more relationship data elements each include a source sub-element and a target sub-element.

18. The method according to claim 17, wherein:
the universal identifiers comprise a plurality of first and second universal identifiers;
the source sub-element corresponds to a first entity data element among the entity data elements and the target sub-element corresponds to a second entity data element among the entity data elements; and
the method further comprises
assigning a first universal identifier to the first entity data element and a second universal identifier to the second entity data element; and
determining a relationship instance reflecting a relationship between the first universal identifier and the second universal identifier according to the one or more relationship data elements.

19. The method according to claim 17, wherein:
the determined one or more relationship instances are bidirectional relationships; and
each of the one or more relationship partitions includes a forward directional relationship sub-partition and a reverse directional relationship sub-partition.

20. The method according to claim 19, further comprising distributing the relationship instances among the forward directional relationship sub-partition and the reverse directional relationship sub-partition.

21. The method according to claim 20 wherein the method further includes:
ranking the determined one or more relationship instances distributed among the forward directional relationship sub-partition according to ones of the universal identifiers associated with the source sub-elements; and
ranking the determined one or more relationship instances distributed among the reverse directional relationship sub-partition according to ones of the universal identifiers associated with the target sub-elements.

22. The method according to claim 15, further comprising distributing the sub-elements among the entity partitions based on sub-element type.

23. The method according to claim 22, wherein the sub-element type is one of an attribute sub-element, a representation sub-element, or a searchable sub-element.

24. The method according to claim 15, wherein:
the universal identifiers comprise a plurality of first and second universal identifiers; and
the method further comprises assigning second universal identifiers to each of the sub-elements.

25. The method according to claim 24, further comprising distributing the sub-elements among the entity partitions based on the second universal identifiers.

26. The method according to claim 15, wherein:
the first universal identifiers are numerical identifiers; and
the method further includes assigning the numerical identifiers sequentially to each of the entity data elements.

27. The method according to claim 26, wherein:
the structured data includes a plurality of entity data element types; and
the method further includes assigning the numerical identifiers sequentially to each entity data element of an entity data element type.

28. The method according to claim 15, further comprising storing the entity partitions and the one or more relationship partitions along with digest metadata in a file on a server.

29. The method according to claim 15, wherein the file is one of an extensible markup language (XML) file or a protobuf (.pbuf) file.

30. A non-transitory computer-readable medium comprising instructions that, when executed by at least one processor, cause the at least one processor to perform operations including:
receiving structured data, the structured data including a plurality of entity data elements and one or more relationship data elements;
assigning first universal identifiers to the entity data elements;
determining one or more relationship instances, the one or more relationship instances corresponding to one or more relationships between the assigned universal identifiers according to the one or more relationship data elements;
segmenting the entity data elements into sub-elements having types, and distributing the sub-elements among a plurality of entity partitions; and
distributing the determined one or more relationship instances among one or more relationship partitions.
